(19) United States
(12) Patent Application Publication
(10) Pub. No.: US 2024/0069300 A1
(43) Pub. Date: Feb. 29, 2024

(54) Camera Filter

(71) Applicant: Jeffrey Overall, Costa Mesa, CA (US)

(72) Inventor: John Kiernan-Lewis, Decatur, GA (US)

(73) Assignee: Polar Pro Filters, Inc., Costa Mesa, CA (US)

(21) Appl. No.: 17/897,977

(22) Filed: Aug. 29, 2022

(51) Int. Cl. G02B 7/00; G02B 5/20; G03B 17/12

(52) U.S. Cl. CPC G02B 7/006; G02B 5/205; G03B 17/12

(57) ABSTRACT

A variable neutral density filter enabling alteration of ND setting while an auxiliary device is coupled with the filter's frame. A ring operatively couples with the frame, and is capable of rotation around an optical axis. The frame may engage and prevent rotation of the ring at certain orientations. Auxiliary device coupling means enable stable coupling of an auxiliary device with the frame, while the ring remains free to rotate and thereby adjust one or more glass elements.

### FIELD OF INVENTION

The present invention relates to camera filters and the attachment of devices to a camera. Specifically, it relates to a variable neutral density filter providing means of stably coupling an auxiliary device.

### BACKGROUND

Neutral Density (ND) camera filters are used by photographers and videographers reduce light transmission through a camera lens. Traditionally, each ND filter provided a specific amount of light reduction, or ND setting. For example, an ND 2 setting allows 50% light transmission; an ND 4 filter allowed 25% light transmission; ND 8 12.5%, etc.

Variable neutral density (VND) filters are camera filters that can be adjusted within a range of ND settings. VND filters utilize multiple pieces of polarized glass, one or more of which is rotated to create different ND settings. Traditional VND filters use rotation of the frame of the camera filter as means of adjusting the ND setting.

Auxiliary devices—such as additional camera filters, a matte box, lens cap—may be coupled with a camera filter to further modify light reaching a camera. When an auxiliary device is so coupled with the frame of a VND filter, the VND filter cannot be adjusted without also adjusting the auxiliary device. This presents a problem when a photographer wants to change the VND setting, but does not want to move a coupled auxiliary device(s).

The present invention solves this problem by providing a VND filter with rotation means that are independent of the frame. This independence enables adjustment of the ND setting without modification of an auxiliary device coupled with the frame.

### SUMMARY

The present invention provides a VND camera filter that maintains the ability to have it's ND setting adjusted while an auxiliary device is coupled with the VND's frame. A frame couples a base glass element. A base aspect of the frame enables coupling with a camera lens. A frame front aspect of the frame enables coupling with an auxiliary device. A frame cavity intercedes through the frame. One or more connectors may connect the base and frame front aspects across a cavity in the frame.

A ring operatively couples with the frame. Operative coupling is used herein to reference two components with an interfacing connection, and capable of movement relative to each other, i.e. movement of one component while the other remains stationary. An inner aspect of the ring penetrates the frame cavity, passing through the frame. The ring couples with an rotating glass element. The rotating glass element is housed within, but does not couple with, the frame.

The ring comprises one or more cut outs. Each cut out is configured to enable movement of the ring relative to the connector(s) and engagement with the connector(s). The cut outs may be arcuate shaped, consistent with the rotation of the ring around an optical axis, and define a rotation range. The rotation range limits the rotation of the ring.

The rotating glass may be rotated around the optical axis while the frame and base glass remain stationary. The rotation range may be configured to enable a specific range of ND stop settings. Interfacing ball and socket aspects of the frame and ring may be configured to provide haptic feedback and/or allow the frame and ring to be locked relative to each other at specific ND stop settings.

The frame may comprise means of coupling another one or more auxiliary devices. A receptacle may provide means of coupling of one or more camera filters with the frame. A groove in an outer surface of the frame may enable coupling of an auxiliary device, such as a matte box or a lens cap. The auxiliary coupling means are configured to allow manual rotation of the ring while the auxiliary device(s) are coupled.

### BRIEF DESCRIPTION OF THE DRAWINGS

FIG. 1A is a left side perspective view of a filter.

FIG. 1B is a left side view of a filter.

FIG. 1C is a front view of a filter.

FIG. 1D is a section view of the filter depicted in FIG. 1C.

FIG. 1E is a section view of the filter depicted in FIG. 1C.

FIG. 2A is a left side perspective view of a filter exploded.

FIG. 2B is a left side view of a filter exploded.

FIG. 3 is a side view of an isolated frame.

FIG. 4A is a back view of a ring isolated.

FIG. 4B is a left side perspective view of a ring isolated.

FIG. 5A is a front and left side perspective view of a filter and modular components with the modular components detached.

FIG. 5B is a back and left side perspective view of a filter and modular components with the modular components detached.

FIG. 6A is a back and right perspective view of a filter and modular components with the modular components detached.

FIG. 6B is a front and right perspective view of a filter and modular components with the modular components detached.

FIG. 7A is a left side view of a filter and auxiliary device coupled with a camera.

FIG. 7B is a left side perspective view of a filter and auxiliary device coupled with a camera.

### DRAWING NUMERALS

100 filter
101 Frame
110 base
111 frame cavity
112 base coupling means
115 connector
120 frame front
121 frame coupling means
124 receptacle
150 ring
151 ring tab
152 ring cutout
153 inner ring
154 socket
155 ball
156 ND stop indicators 160 rotating glass
200 Auxiliary filter
210 Auxiliary filter glass
212 Auxiliary filter frame
220 slider
300 Auxiliary device
400 rotation range
500 Optical axis

### DETAILED DESCRIPTION OF THE DRAWINGS

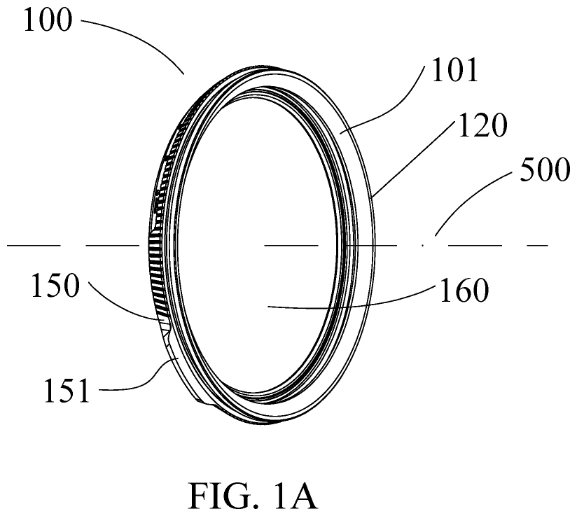

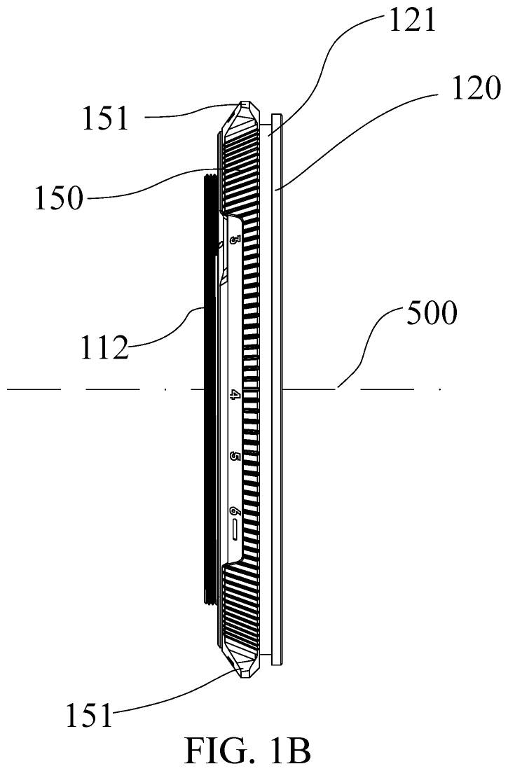

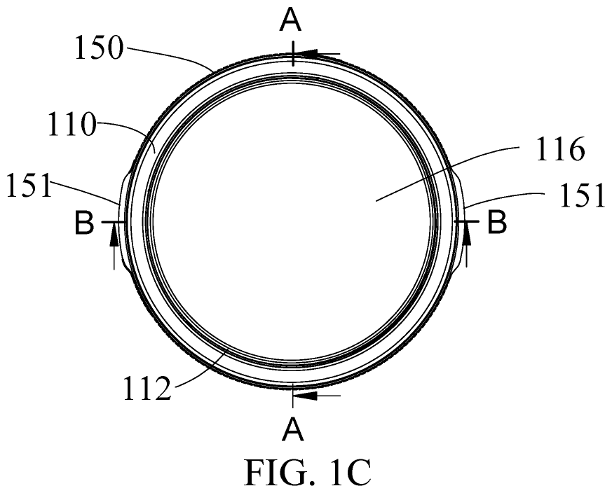

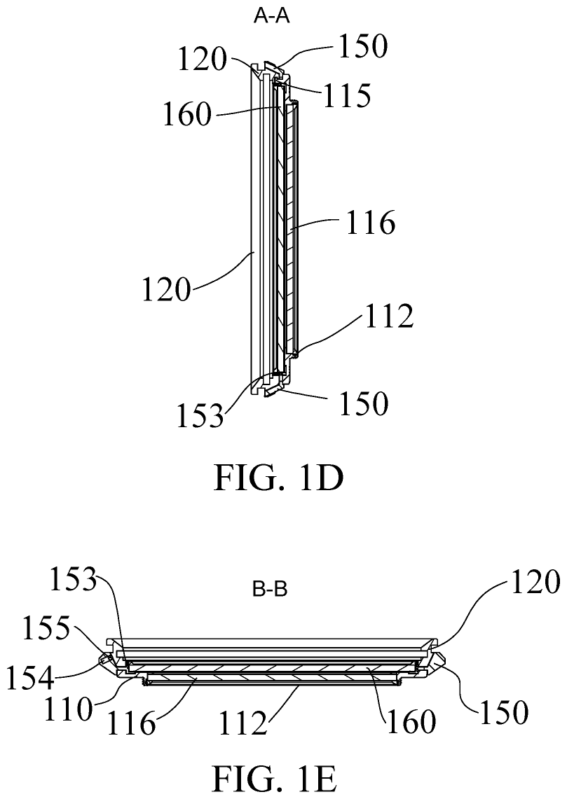

A ring 150 and frame 101 components operatively couple to create the outer surface of a filter 100. A base 110 aspect of the frame 101 may have base coupling means 112 configured to couple with a camera lens or other device. The male aspect of a threaded coupling system may comprise the exemplary coupling means 112 (see FIGS. 1B-E).

A connector(s) 115 may couple the base 110 with a front 120 aspect of the frame 101. The connector(s) are configured to create a frame cavity 111 separating at least two surfaces of the base 110 and front 120.

The base 110 may encircle a base glass 117 element, coupling the base glass 117 at the perimeter and holding it stable against movement relative to the base 110.

The ring 150 may encircle portions of the base 110 and frame 120. A portion of the ring 150 extends inward into the frame cavity 111 and is sandwiched between the base 110 and frame 120 (see FIGS. 1D and 1E). An inner rim of the ring 150 may couple a rotating glass element 160. The frame cavity 111 is configured to allow the ring 150 to rotate relative to the stable aspects (110, 120) of the frame 101.

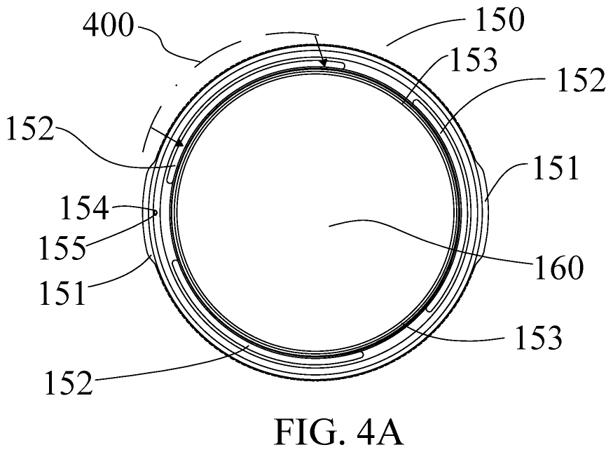

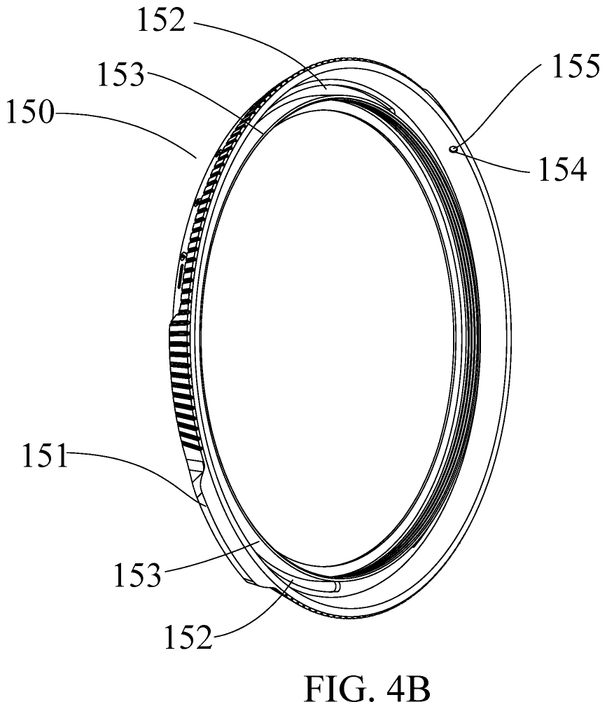

One or more ring cutouts 152 may perforate the ring 150. The ring cutout(s) 152 are configured to enable to connector(s) 115 to pass through the operatively coupled ring 150 and couple with the frame 120. The cut out(s) 152 may be arc shaped to enable rotation of the ring 152 (see FIG. 4A). The ring cutout(s) 152 may define a stop range for the ring 150. An inner 153 aspect of the ring 150 may couple the rotating glass 160. The inner aspect 153 may contour an inner surface of the base 110 and an inner surface of the front filter 120, enabling rotation of the ring 150 while also preventing non-rotation movement of the ring 150 relative to the stable aspects (110, 120).

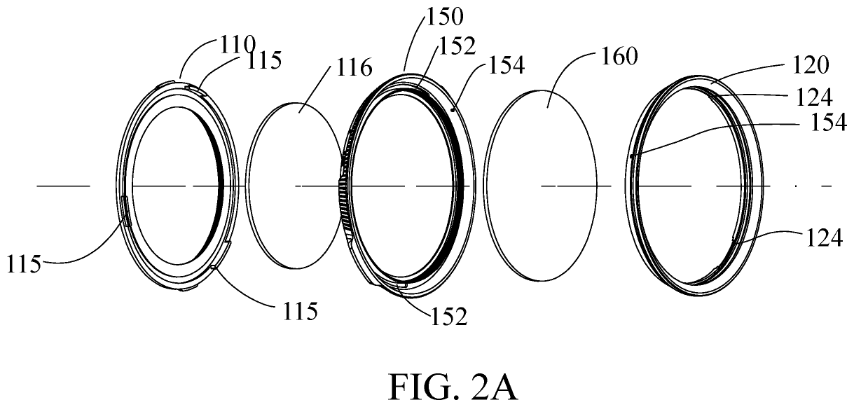

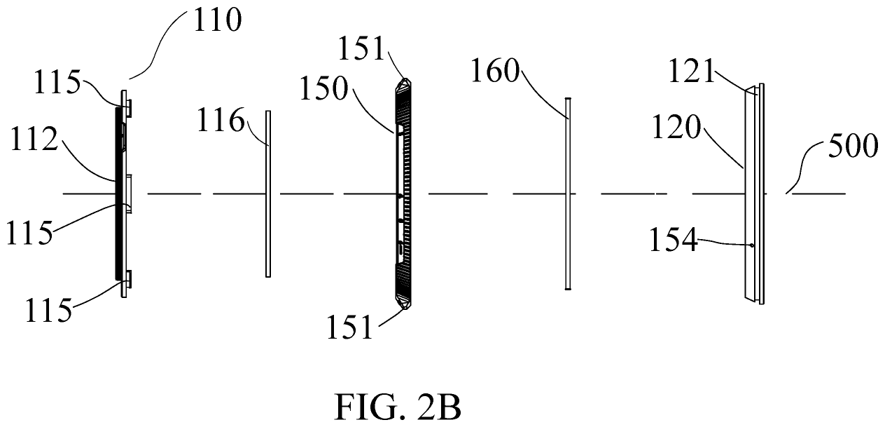

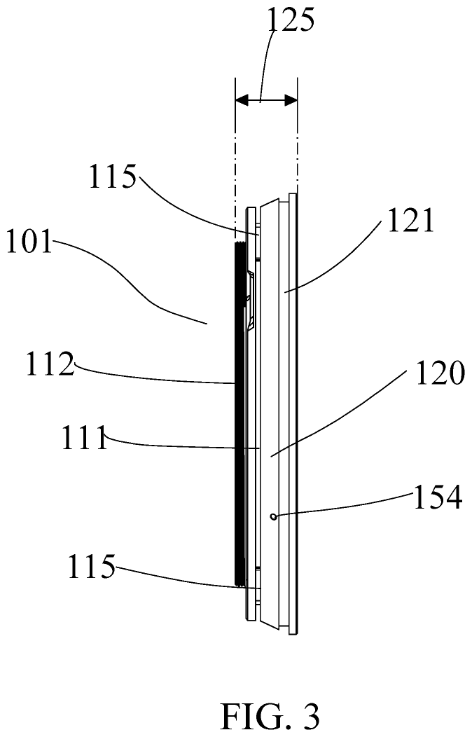

The frame cavity 111 may be configured at a tolerancing that enables the ring 150 to rotate around an optical axis 500 while preventing non rotation movement of the ring 150. The optical axis 500 is included for reference and is a line extending through the center of each glass elements (116, 160) and extending perpendicular to the planar surfaces of the glass elements (116, 160) (See FIGS. 1A-2B).

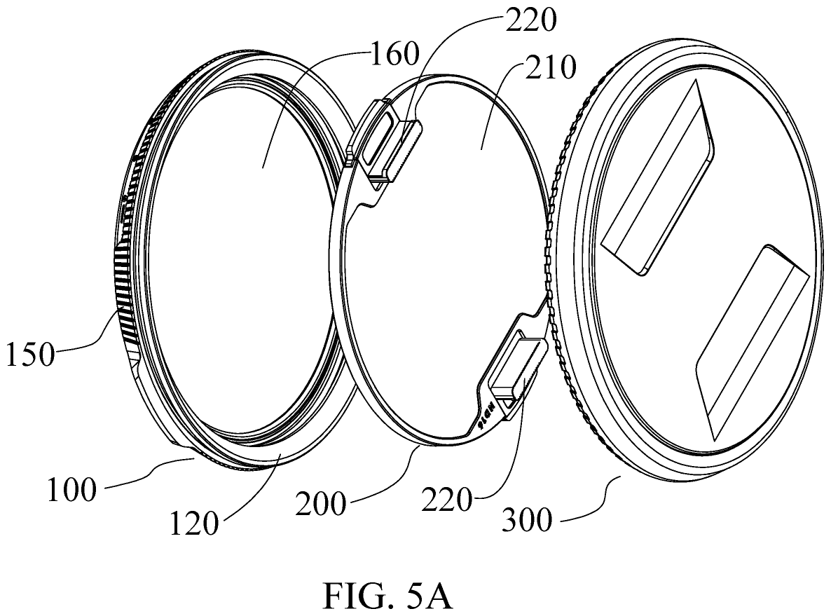

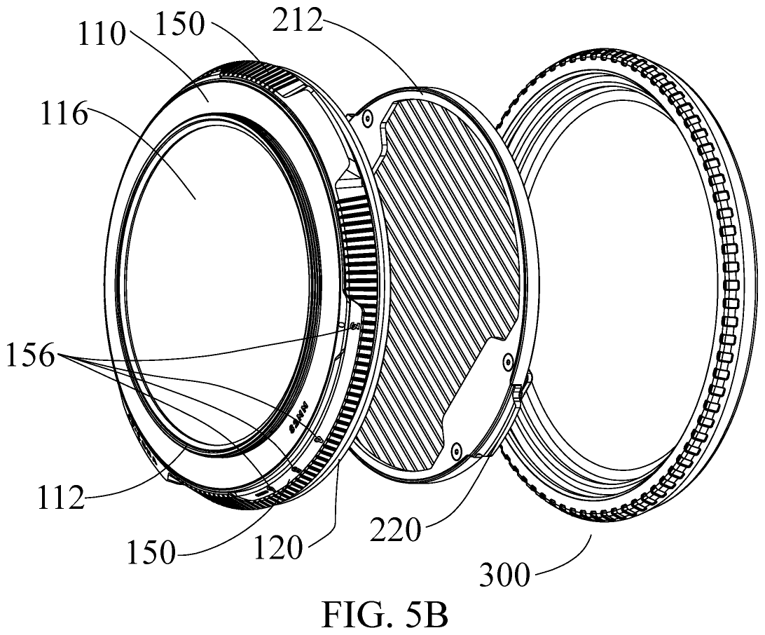

The base glass 116 and rotating glass 160 may be polarized. Rotation of the rotating glass 160 around the optical axis 500 may create different light ND settings. An exemplary stop range 400 may enable rotation of the ring 150, and thereby the rotating glass 160, to create neutral density settings of a minimum 3 stops and a maximum of 6 stops. “Stops” is used herein to refer to the light transference on an f-stop spectrum. The ND number is the denominator, if the numerator is 1, of the fractional transmittance of the filter: ND2 filter has a fractional transmittance of 50%; an ND4 has a fractional transmittance of 25%; an ND8 has a fractional transmittance of 12.5%; etc. In the exemplary embodiment, the rotation range of the filter may allow for 3-6 ND stop orientations, as identified by ND stop identifiers 156 on the ring 150 (see FIG. 5B). In such an embodiment, the highest (6) and lowest (3) ND orientations may correspond with the connector(s) 115 contacting one extreme of the cut out 152 it passes through.

The cut out(s) 152 and connector(s) 115 may be configured to prevent rotation of the glass components (116, 160) into an orientation in which there is vignetting, cross polarization or other undesirable optical effects.

Cut out(s) 152 in the ring 150 enable the connectors 115 to pass through the ring 150 to couple the base 110 and frame front 120 (see FIGS. 4A-B). The cut out(s) 152 may be arcuate and define a rotation range 400. A connector 115 passing through the cut out 152 will contact the edge of the cut out 152, thereby preventing rotation of the ring 150 out of the rotation range 400.

In an exemplary embodiment, three connectors 115 (see FIGS. 2A-B) connect the base 110 and frame front 120. Each connector 115 passes through one of three cut outs in the exemplary ring 150 (see FIGS. 4A-B).

One or more sockets 154 may be placed at intervals on an outer surface of the frame 120 and an inner surface of the ring 150. A ball 155 may be partially housed within a socket 154. The ring 150 may be rotated until a socket 154 on the ring 150 aligns with a socket on the frame 120.

When aligned, the ball 155 may be urged into the socket 154. This may provide haptic feedback to a user. In other embodiments, alignment of two sockets 154 may lock the ring 150 and frame 101 relative to each other against a predetermined amount of force. A predetermined amount of force may be applied to the ring 150 to urge the ball 155 out of the socket 154, allowing rotation of the ring 150. The socket(s) 154 and ball(s) 155 may be configured to create specific stop orientations within the stop range 400. For example, in an embodiment enabling 3 through 6 stop orientations, the sockets may be configured to create a 4 stop orientation and a 5 step orientation within the stop range. Ring tabs 151 may extend from the perimeter of the ring 150 to allow application of rotation force to the ring 150.

The front filter 120 may comprise receptacle(s) 124 enabling coupling of an auxiliary device, such as an auxiliary filter 200. An auxiliary filter 200 may comprise coupling aspects enabling it to couple with the front filter 120. Spring loaded sliders 220 may extend from the perimeter of an auxiliary filter 200 (see FIGS. 5A-B). Force may be applied to the slides 220 to retract them, enabling insertion into the frame 120. Once inserted into the frame, the springs may urge each slide into a receptacle 124, thereby coupling the auxiliary filter 200 with the filter 100. The auxiliary filter does not contract the ring 150 or rotating glass 160, and does not interfere with rotation of the ring 150 around the optical axis 500. The coupled auxiliary filter does not contact or otherwise interfere with rotation of the ring 150 or articulating glass 160.

A auxiliary device coupling means 121 aspect of the frame 101 may enable coupling of an auxiliary device 300, such as a lens cap or matte box. auxiliary device coupling means 121 may be a groove in an outer surface of the frame front 120. An auxiliary device may be configured to engage and couple with the auxiliary device coupling means by pressure fitting. The auxiliary device 300 does not contract the ring 150 or rotating glass 160, and does not interfere with rotation of either (150, 160) around the optical axis 500.

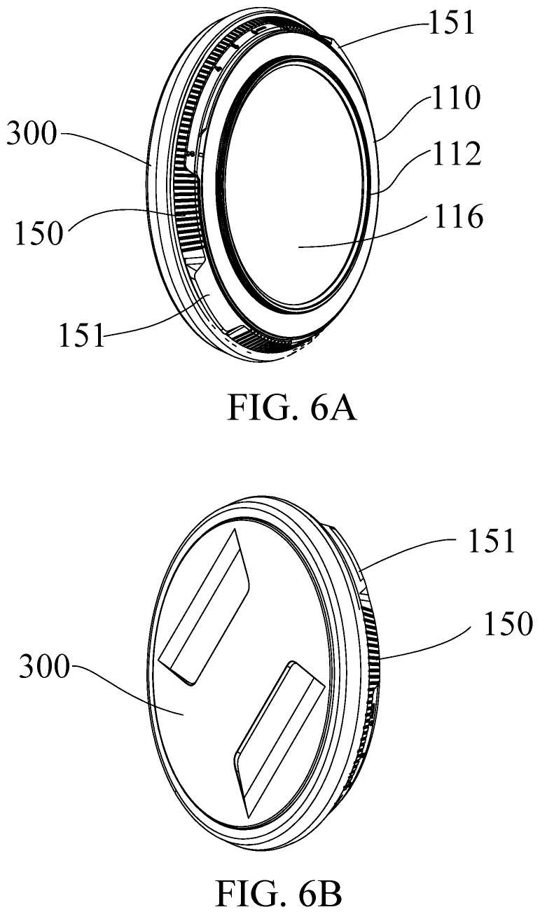

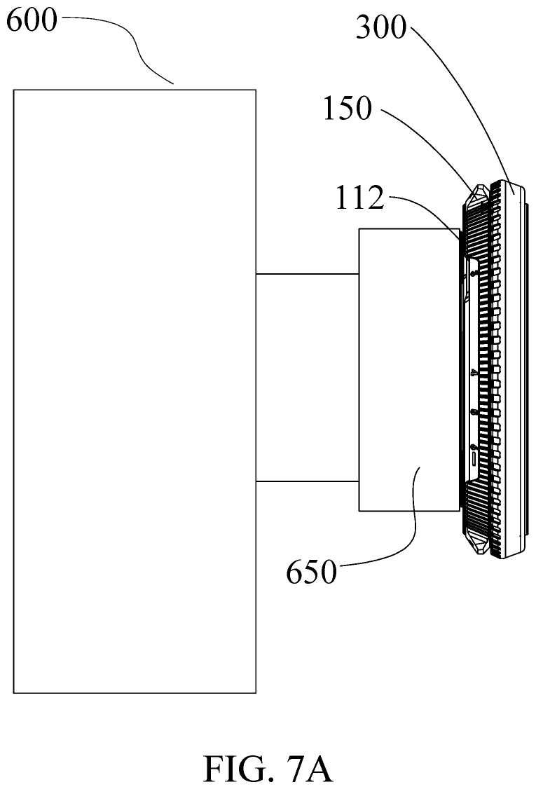

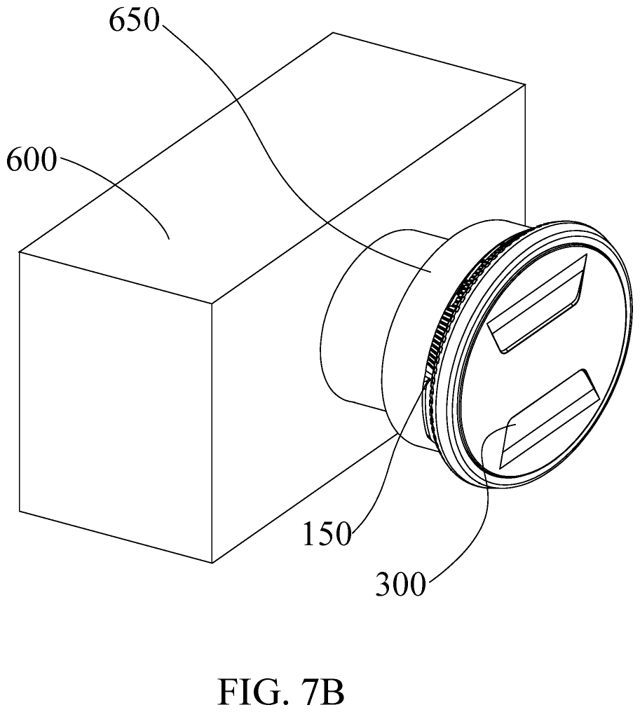

The frame may enable simultaneous coupling of an auxiliary filter 200 and auxiliary device 300 (see FIGS. 5A-6B). A coupled auxiliary filter 200 may be housed within the frame 120 when coupled. This orientation aligns the filter 200 with the optical axis and enables filter stacking image alteration. The auxiliary device 300 may be configured to couple with the auxiliary device coupling means 121. Protective auxiliary devices 300 such as a lens cap (see FIGS. 6A-B) may be configured to cover a coupled auxiliary filter 200 when coupled with the auxiliary device coupling means 121.

The foregoing disclosure is intended to be illustrative and not limiting the scope of the invention. Merely exemplary embodiments and methods related to the invention are discussed and described. As will be understood by those familiar to the art, the disclosed subject matter may be embodied in other forms or methods without departing from the essence of the invention.

I claim:

1. A camera filter, comprising:
a. a frame, the frame comprising a base aspect configured to couple with an optical device;
b. the frame coupling a base glass element;
c. the frame comprising a frame front;
d. the frame front and base being positioned to create a gap;
e. at least one connector coupling the frame front and the base;
f. a ring, the ring operatively coupling with the frame, such that the ring and articulating glass can be rotated around an optical axis;
g. the ring extending into the gap and coupling with a rotating glass element;
h. the ring comprising a cut out through which the at least one connector passes;
i. the cut out defining a rotation range, the rotation range limiting the rotation of the ring, and thereby the articulating glass element around the optical axis;
j. the frame comprising auxiliary device coupling means, whereby an auxiliary device may be coupled with the frame;
k. the auxiliary device coupling means being configured to allow rotation of the ring relative to the optical axis while an auxiliary device is coupled with the frame.

2. A camera filter, comprising:
a. a frame comprising a base, a front frame, and a plurality of connectors, the connectors as means of coupling the base and front frame;
b. a base glass, the base glass coupling with the frame and being held stationary thereto;
c. a ring, the ring extending through a gap between the base and frame front;
d. an articulating glass piece, the articulating glass coupling with the ring and being held stationary thereto;
e. the ring and frame operatively coupling, whereby the ring can be rotated around an optical axis;
f. the ring comprising a plurality of cut outs;
g. the connectors and cut outs configured to contact at certain orientation, thereby creating a rotation range.

3. camera filter, comprising:
a. a base glass element and an articulating glass element, each of the glass elements comprising a polarizer;
b. a frame coupling the base glass element and a ring coupling the articulating glass element;
c. the ring operatively coupling with the frame, whereby the ring and articulating glass element are capable of rotation axis perpendicular to the planar surfaces of the glass elements;
d. the frame comprising a base aspect and a front frame aspect;
e. a plurality of connectors, the plurality of connectors coupling the base aspect and front frame aspect;
f. the ring comprising a plurality of cut outs;
g. the ring and frame being configured so that a connector engages a cut out when and prevents movement in one direction when the ring is rotated to a particular orientation, thereby creating a rotation range;
h. the base aspect comprising base coupling means;
g. the front frame aspect comprising auxiliary device coupling means configured to couple an auxiliary device while the ring remains free to rotate around an optical axis and within the rotation range.
